(19) United States
(12) Patent Application Publication
(10) Pub. No.: US 2026/0109187 A1
(43) Pub. Date: Apr. 23, 2026

(54) AMPHIBIOUS VEHICLE WITH LIFTABLE SUSPENSIONS

(71) Applicants: Zhuhai College of Science and Technology., Zhuhai (CN); Zhuhai Meixinao yacht propulsion System Co., LTD., Zhuhai (CN)

(72) Inventors: Baoqin Deng, Zhuhai (CN); Mengqi Deng, Zhuhai (CN); Zhuo Yang, Zhuhai (CN); Yanping Deng, Zhuhai (CN); Weidong Lin, Zhuhai (CN); Kang Deng, Zhuhai (CN); Yongzhen Wang, Zhuhai (CN)

(21) Appl. No.: 18/988,932

(22) Filed: Dec. 20, 2024

(30) Foreign Application Priority Data
Oct. 18, 2024 (CN) 202411460339.X

(51) Int. Cl. B60F 3/00

(52) U.S. Cl. CPC B60F 3/003; B60F 2301/04

(57) ABSTRACT

An amphibious vehicle with liftable suspensions includes a vehicle body. A driving assembly, a front axle transmission assembly, and a rear axle transmission assembly are disposed in the vehicle body. The front axle transmission assembly and the rear axle transmission assembly are respectively arranged on two ends of the drive assembly, and the drive assembly is in transmission connection with the front axle transmission assembly and the rear axle transmission assembly. The drive assembly enables the front axle transmission assembly and the rear axle transmission assembly to drive the front axle transmission shaft components and the first rear axle transmission shafts, thereby to achieve four-wheel travelling on land. Additionally, the amphibious vehicle can adjust heights of the vehicle body according to different road conditions using air springs and worm wheels, thereby adjusting a ground clearance to adjust various road surfaces and speeds.

### TECHNICAL FIELD

The disclosure relates to the technical field of amphibious vehicles, and particularly to an amphibious vehicle with liftable suspensions.

### BACKGROUND

An amphibious vehicle is a kind of novel transportation, characterized by its ability to travel both on water and land, thus holding broad prospects for future development. Firstly, the amphibious vehicle can be used for rescues and emergency responses. In events of natural or man-made disasters, the amphibious vehicle can quickly reach a scene and travel on both water and land, thereby facilitating rescues and emergency responses.

A transmission system of the amphibious vehicle typically includes an engine, a front axle, a rear axle, and a turbine. When traveling on land is required, the engine drives transmission components in the front axle and the rear axle to thereby drive tires connected to the front axle and the rear axle to rotate, achieving the purpose of traveling on the land. When traveling in water is needed, the turbine drives thrusters (i.e., propellers) to rotate, enabling movement in the water.

However, current traveling conditions for the existing amphibious vehicle are quite complex. As to the existing amphibious vehicle, in order to be designed to carry more passengers, is provided with a longer vehicle body. If suspensions of the amphibious vehicle are low, the vehicle's road passability is reduced, making it inconvenient to travel on rough land. Whereas, if the suspensions of the amphibious vehicle are high, which would cause the amphibious vehicle to wobble or even tip over when traveling at a higher speed on a smooth land. Therefore, the disclosure aims to provide an amphibious vehicle with liftable suspensions.

### SUMMARY

In order to overcome the shortcomings in the related art, the disclosure provides an amphibious vehicle with liftable suspensions, which solves the problem that suspensions of the amphibious vehicle are generally fixed and difficult to adapt to various complex road conditions.

To achieve the above objectives, the disclosure provides the following technical solution: an amphibious vehicle with liftable suspensions.

The amphibious vehicle with liftable suspensions includes a vehicle body, a driving assembly mounted inside the vehicle body, a front axle transmission assembly mounted inside the vehicle body, and a rear axle transmission assembly mounted inside the vehicle body. The front axle transmission assembly and the rear axle transmission assembly are respectively arranged on two ends of the drive assembly, and the drive assembly is in transmission connection with the front axle transmission assembly and the rear axle transmission assembly. The front axle transmission assembly includes a front axle transmission box and air springs. The front axle transmission box is fixedly mounted inside the vehicle body, two ends of the front axle transmission box respectively mounted with front axle transmission shaft components, and the front axle transmission shaft components are in transmission connection with the drive assembly. The air springs are disposed above the front axle transmission shaft components, respectively, and are configured to adaptively adjust a height of front axle and thereby automatically adjust, through being connected to a vehicle-mounted control system, the height of front axle according to different road conditions. The rear axle transmission assembly includes a rear axle transmission box and electric worm-gear lifting mechanisms. The rear axle transmission box is fixedly disposed inside the vehicle body, two ends of the rear axle transmission box are mounted with first rear axle transmission shafts, and the first rear axle transmission shafts are in transmission connection with the drive assembly. Each of electric worm-gear lifting mechanisms includes a worm wheel, a worm shaft, and a driving motor. The worm wheel is rotatably mounted inside the vehicle body, and the worm wheel is movably sleeved on an outer side of an end of the first rear axle transmission shaft. The worm shaft is meshed with the worm wheel, and the driving motor is connected to the worm shaft and configured to drive the worm wheel to rotate to precisely adjust a height of rear axle and thereby automatically adjust, through being connected to the vehicle-mounted control system, the height of rear axle according to water and land traveling states.

In an embodiment, the vehicle body includes a streamlined main body, a high-strength vehicle frame, and vehicle wheels driven by wheel hubs. The streamlined main body is fixedly sleeved on an outer side of the high-strength vehicle frame, and the high-strength vehicle frame is mounted on outer sides of the drive assembly, the front axle transmission assembly, and the rear axle transmission assembly. The vehicle wheels driven by the wheel hubs are in transmission connection with the front axle transmission shaft components and the first rear axle transmission shafts, respectively. The wheel hubs are embedded with driving motors and thereby capable of independently controlling driving torques of the respective vehicle wheels according to driving needs

In an embodiment, the driving assembly includes a hybrid power system, a front axle transfer shaft, and a rear axle transfer shaft. The hybrid power system includes an engine, an electric motor, and a transfer case. The engine and the electric motor are in transmission connection with the transfer case for flexible power distribution and switching. Two ends of the front axle transfer shaft are in transmission connection with the transfer case and the front axle transmission assembly, respectively. Two ends of the rear axle transfer shaft are in transmission connection with the transfer case and the rear axle transmission assembly, respectively.

In an embodiment, a retractable thruster is mounted inside the vehicle frame, and an end of the retractable thruster passes through the streamlined main body and extends outwards. A spray pump transmission shaft is mounted between the transfer case and the retractable thruster. The spray pump transmission shaft is configured to supply power when the amphibious vehicle travels on water, and control retraction and power output of the retractable thruster through the vehicle-mounted control system.

In an embodiment, a front axle transmission seat is mounted inside the front axle transmission box, and an end of each of the front axle transmission shaft components is connected to the front axle transmission seat through a cardan joint, thereby achieving angular adaptability between each of the front axle transmission shaft components and the front axle transmission seat. Another end of each of the front axle transmission shaft components extends outwards and is connected to a front axle steering knuckle. A telescopic shaft is disposed in the air spring, and a bottom end of the telescopic shaft extends downwards and is rotatably disposed on a top of the front axle steering knuckle. Air pressure in air spring of each of the front axle transmission shaft components is configured to be controlled to adaptively adjust the height of front axle.

In an embodiment, each of the front axle transmission shaft components includes a first front axle transmission shaft, a second front axle transmission shaft, and a third front axle transmission shaft. The second front axle transmission shaft is connected to the front axle transmission seat through the cardan joint, and an end of the third front axle transmission shaft penetrates through the front axle steering knuckle and is connected to one of the vehicle wheels driven by the wheel hubs. The second front axle transmission shaft and the third front axle transmission shaft are in transmission connection with each other through constant velocity joints to ensure a smooth transmission of the front axle transmission shaft component during a steering and a height adjustment process.

In an embodiment, an end of a front axle upper swing arm and an end of a front axle lower swing arm are rotatably connected to a side wall of the front axle transmission box, another end of the front axle upper swing arm is hinged to a bottom end of the telescopic shaft, and another end of the front axle lower swing arm is hinged to a bottom end of the front axle steering knuckle. A fixed frame is fixedly mounted on a top of the front axle transmission box, and a front axle shock absorber with adjustable damping is disposed between an outer side of the fixed frame and the front axle upper swing arm. The front axle shock absorber is configured to buffer vibrations of front axle under different road conditions and to adjust a damping value in real-time according to commands of the vehicle-mounted control system.

In an embodiment, a rear axle transmission seat is mounted inside the rear axle transmission box, an end of each of the first rear axle transmission shafts is connected to the rear axle transmission seat through a cardan joint, thereby achieving angular adaptability between each of the first rear axle transmission shafts and the rear axle transmission seat. Another end of each of the first rear axle transmission shafts is in transmission connection with an end of a second rear axle transmission shaft, another end of the second rear axle transmission shaft is in transmission connection with an end of a third rear axle transmission shaft, another end of the third rear axle transmission shaft is connected to one of the vehicle wheels driven by the wheel hubs. A rear axle knuckle is movably sleeved on an outer side of the third rear axle transmission shaft, a side wall of the worm wheel of each of the electric worm-gear lifting mechanisms and a top end and a bottom end of the rear axle knuckle respectively have a rear axle upper swing arm and a rear axle lower swing arm hinged therebetween, and a rear axle shock absorber with adjustable damping is disposed between the side wall of the worm wheel and an outer side of the rear axle knuckle. Each of the electric worm-gear lifting mechanisms in cooperation with a swing arm suspension system are configured to achieve precise adjustment of the height of rear axle and buffering of rear axle.

In an embodiment, the first rear axle transmission shafts and the second rear axle transmission shaft are in transmission connection with each other through a constant velocity joint arranged therebetween, and the second rear axle transmission shaft and the third rear axle transmission shaft are in transmission connection with each other through a constant velocity joint arranged therebetween, thereby ensuring a smooth transmission of the first through third rear axle transmission shafts during a height adjustment process.

In an embodiment, the driving motor is a brushless motor. The vehicle-mounted control system is configured to precisely control a speed and a torque of the brushless motor to drive the worm shaft to rotate and thereby to drive the worm wheel to rotate, achieving a millimeter-level precise adjustment of the height of rear axle, and automatically switch height adjustment strategies based on water and land traveling states to improve passability and adaptability of the amphibious vehicle.

The beneficial effects of the disclosure are as follows.

1. The amphibious vehicle with liftable suspensions of the disclosure, during use, utilizes the drive assembly to enable the front axle transmission assembly and the rear axle transmission assembly to drive the front axle transmission shaft components and the first rear axle transmission shafts, to achieve four-wheel travelling on land. Additionally, the amphibious vehicle can adjust the height of the vehicle body according to different road conditions using the air springs and worm wheels, thereby adjusting a ground clearance to adapt various road surfaces and vehicle speeds.

2. When the driving motor is working, the driving motor can rotate the worm shafts, thereby driving the worm wheels to rotate. As the worm wheels rotate, the worm wheels induce an arcuate motion of the rear axle knuckles located at sides of the worm wheels, respectively. Concurrently, the rear axle upper swing arms, the rear axle lower swing arms, the rear axle shock absorbers, the second rear axle transmission shafts, and the third rear axle transmission shafts, which are interconnected with the worm wheels and the rear axle knuckles, are moved accordingly, thereby achieving the height adjustment. The driving motor is a brushless motor. The vehicle-mounted control system is configured to precisely control a speed and a torque of the brushless motor to drive the worm shaft to rotate and thereby to drive the worm wheel to rotate, achieving a millimeter-level precise adjustment of the height of rear axle, and automatically switch height adjustment strategies based on water and land traveling states to improve passability and adaptability of the amphibious vehicle.

3. In the amphibious vehicle with liftable suspensions, a side wall of the worm wheel of each of the electric worm-gear lifting mechanisms and a top end and a bottom end of the rear axle knuckle respectively have a rear axle upper swing arm and a rear axle lower swing arm hinged therebetween, and a rear axle shock absorber with adjustable damping is disposed between the side wall of the worm wheel and an outer side of the rear axle knuckle. Each of the electric worm-gear lifting mechanisms in cooperation with a swing arm suspension system are configured to achieve precise adjustment of the height of rear axle and buffering of rear axle.

### BRIEF DESCRIPTION OF DRAWINGS

In order to provide a clearer explanation of the embodiments of the disclosure or the technical solutions in the related art, a brief introduction will be given to the attached drawings required for the description of the embodiments or the related art. It is apparent that the attached drawings described below are only some embodiments of the disclosure. For those skilled in the art, other drawings can be obtained based on these drawings without creative labor.

FIG. 1 illustrates a schematic structure diagram of the disclosure.

FIG. 2 illustrates a schematic structure diagram of a vehicle body, a driving assembly, a front axle transmission assembly, and a rear axle transmission assembly of the disclosure.

FIG. 3 illustrates a schematic structure diagram of the driving assembly, the front axle transmission assembly, and the rear axle transmission assembly of the disclosure.

FIG. 4 illustrates a schematic structure diagram of the vehicle body and the front axle transmission assembly of the disclosure.

FIG. 5 illustrates a schematic structure diagram of the front axle transmission assembly of the disclosure.

FIG. 6 illustrates a schematic structure diagram of a portion of the front axle transmission assembly in the disclosure.

FIG. 7 illustrates a schematic structure diagram of the vehicle body and the rear axle transmission assembly of the disclosure.

FIG. 8 illustrates a schematic structure diagram of the rear axle transmission assembly of the disclosure.

FIG. 9 illustrates a first schematic structure diagram of a portion of the rear axle transmission assembly in the disclosure.

FIG. 10 illustrates a second schematic structure diagram of the portion of the rear axle transmission assembly in the disclosure.

### DESCRIPTION OF REFERENCE NUMERALS

1. vehicle body; 11. streamlined main body; 12. high-strength vehicle frame; 13. vehicle wheel; 14. wheel hub; 2. driving assembly; 21. engine; 22. transfer case; 23. front axle transfer shaft; 24. spray pump transmission shaft; 25. rear axle transfer shaft; 26. retractable thruster; 3. front axle transmission assembly; 31. front axle transmission box; 32. front axle transmission seat; 33. front axle transmission shaft component; 331. first front axle transmission shaft; 332. second front axle transmission shaft; 333. third front axle transmission shaft; 334. constant velocity joint; 34. front axle steering knuckle; 35. air spring; 36. telescopic shaft; 37. fixed frame; 38. front axle upper swing arm; 381. front axle shock absorber; 39. front axle lower swing arm; 4. rear axle transmission assembly; 41. rear axle transmission box; 42. rear axle transmission seat; 43. first rear axle transmission shaft; 44. second rear axle transmission shaft; 45. third rear axle transmission shaft; 46. rear axle knuckle; 461. rear axle upper swing arm; 462. rear axle lower swing arm; 463. rear axle shock absorber; 47. worm wheel; 48. driving motor; 49. worm shaft.

### DETAILED DESCRIPTION OF EMBODIMENTS

In order to clarify the purpose, technical solutions, and advantages of the embodiments of the disclosure, a clear and complete description of the technical solutions in the embodiments of the disclosure is provided. Apparently, the described embodiments are a part of the embodiments of the disclosure, not all of them. Based on the embodiments of the disclosure, all other embodiments obtained by those skilled in the art without creative labor are within the scope of protection of the disclosure.

The disclosure solves the problem that suspensions of an amphibious vehicle in the related art is generally fixed and difficult to adapt to various complex road conditions by providing an amphibious vehicle with liftable suspensions. During use, a driving assembly 2 enables a front axle transmission assembly 3 and a rear axle transmission assembly 4 to drive front axle transmission shaft components 33 and first rear axle transmission shafts 43, thereby achieving four-wheel travelling on land. In addition, the amphibious vehicle in the disclosure can adjust a height of a vehicle body 1 according to different road conditions using air springs 35 and worm wheels 47, thereby adjusting a ground clearance of the vehicle body 1 to adapt to various road conditions and speeds.

In order to better understand the above technical solution, a detailed explanation of the above technical solution will be provided below in conjunction with the attached drawings in the specification and specific embodiments.

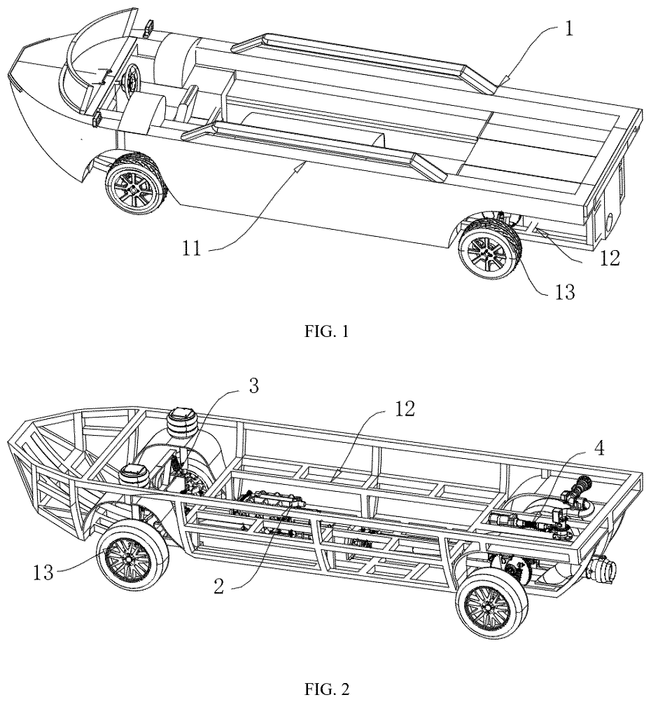

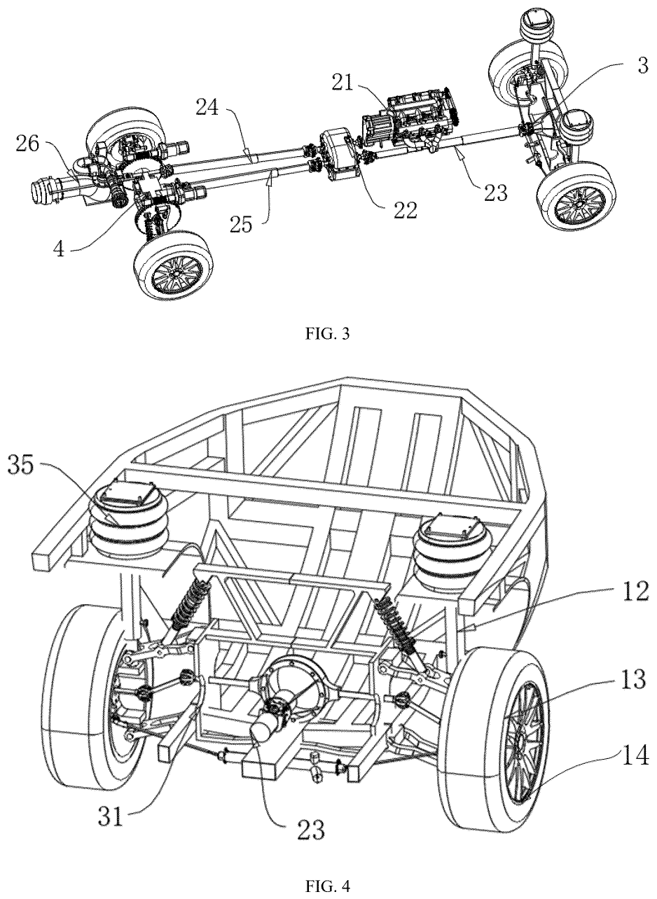

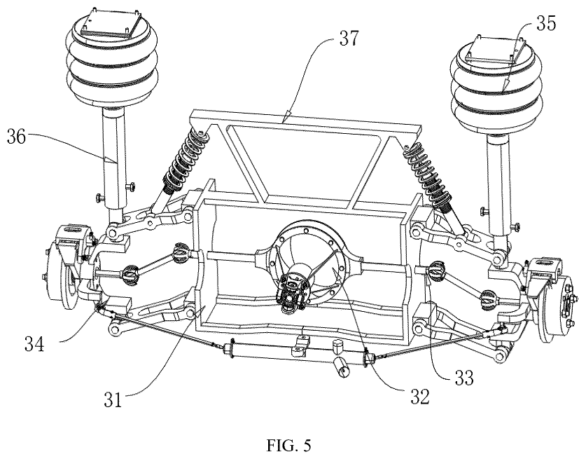

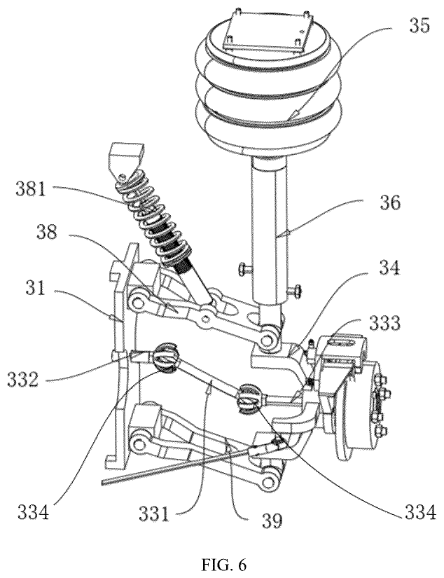

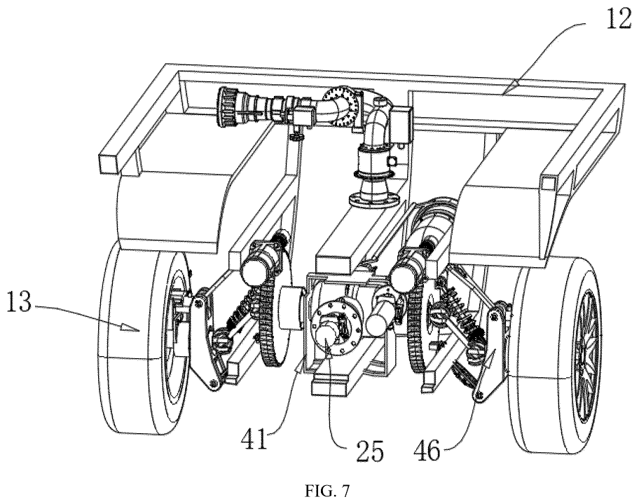

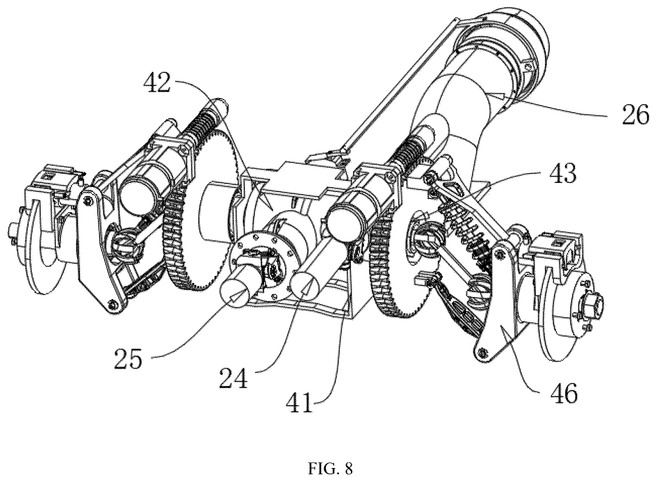

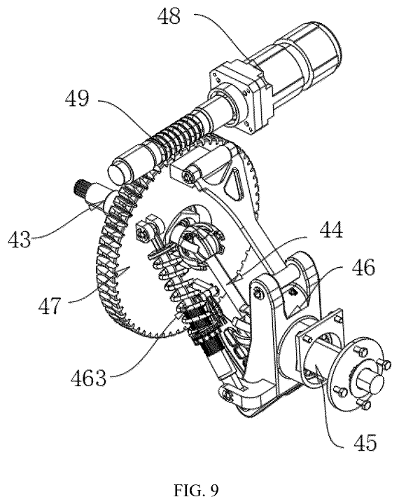

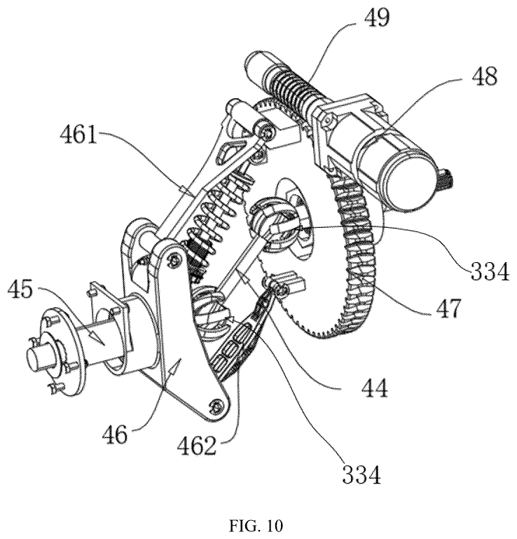

An amphibious vehicle with liftable suspensions is provided. As shown in FIGS. 1-10, the amphibious vehicle includes a vehicle body 1, a driving assembly 2 mounted inside the vehicle body 1, a front axle transmission assembly 3 mounted inside the vehicle body 1, and a rear axle transmission assembly 4 mounted inside the vehicle body 1. The front axle transmission assembly 3 and the rear axle transmission assembly 4 are respectively arranged on two ends of the drive assembly 2, and the drive assembly 2 is in transmission connection with the front axle transmission assembly 3 and the rear axle transmission assembly 4. The front axle transmission assembly 3 includes a front axle transmission box 31 and air springs 35. The front axle transmission box 31 is fixedly mounted inside the vehicle body 1, two ends of the front axle transmission box 31 are respectively mounted with front axle transmission shaft components 33, and the front axle transmission shaft components 33 are in transmission connection with the drive assembly 2. The air springs 35 are disposed above the front axle transmission shaft components 33, respectively, and are configured to adaptively adjust a height of front axle and thereby automatically adjust, through being connected to a vehicle-mounted control system, the height of front axle according to different road conditions. The vehicle-mounted control system is an existing mature technology, and this embodiment will not be elaborated here. The rear axle transmission assembly 4 includes a rear axle transmission box 41 and electric worm-gear lifting mechanisms. The rear axle transmission box 41 is fixedly mounted inside the vehicle body 1, two ends of the rear axle transmission box 41 are mounted with first rear axle transmission shafts 43, and the first rear axle transmission shafts 43 are in transmission connection with the drive assembly 2. Each of the electric worm-gear lifting mechanisms includes a worm wheel 47, a worm shaft 49, and a driving motor 48. The worm wheel 47 is rotatably mounted inside the vehicle body 1, and the worm wheel 47 is movably sleeved on an outer side of an end of the first rear axle transmission shaft 43. The worm shaft 49 is meshed with the worm wheel 47, and the driving motor 48 is connected to the worm shaft 49 and configured to drive the worm wheel 47 to rotate to precisely adjust a height of rear axle and thereby automatically adjust, through being connected to the vehicle-mounted control system, the height of rear axle according to water and land traveling states.

During use of the amphibious vehicle, the driving assembly 2 enables a front axle transmission assembly 3 and a rear axle transmission assembly 4 to drive front axle transmission shaft components 33 and first rear axle transmission shafts 43, thereby achieving four-wheel travelling on land. In addition, the amphibious vehicle in the disclosure can adjust a height of a vehicle body 1 according to different road conditions using the air springs 35 and the worm wheels 47, thereby adjusting a ground clearance of the vehicle body 1 to adapt to various road conditions and speeds.

When the driving motor 48 is working, the driving motor 48 can rotate the worm shafts 49, thereby driving the worm wheels 47 to rotate. As the worm wheels 47 rotate, the worm wheels 47 induce an arcuate motion of the rear axle knuckles 46 located at sides of the worm wheels, respectively. Concurrently, the rear axle upper swing arms 461, the rear axle lower swing arms 462, the rear axle shock absorbers 463, the second rear axle transmission shafts 44, and the third rear axle transmission shafts 45, which are interconnected with the worm wheels 47 and the rear axle knuckles 46, are moved accordingly, thereby achieving the height adjustment.

In an embodiment, the vehicle body 1 includes a streamlined main body 11, a vehicle frame 12, and vehicle wheels 13 driven by wheel hubs 14. The streamlined main body 11 is fixedly sleeved on an outer side of the vehicle frame 12, and the vehicle frame 12 is mounted on outer sides of the drive assembly 2, the front axle transmission assembly 3, and the rear axle transmission assembly 4. The vehicle wheels 13 driven by the wheel hubs 14 are in transmission connection with the front axle transmission shaft components 33 and the first rear axle transmission shafts 43, respectively. The wheel hubs 14 are an use of an existing technology, and the wheel hubs 14 are embedded with driving motors and thereby capable of independently controlling driving torques of the respective vehicle wheels according to driving needs.

Specifically, the driving assembly 2 includes a hybrid power system, a front axle transfer shaft 23, and a rear axle transfer shaft 25. The hybrid power system includes an engine 21, an electric motor, and a transfer case 22. The engine 21 and the electric motor are in transmission connection with the transfer case 22 for flexible power distribution and switching. Two ends of the front axle transfer shaft 23 are in transmission connection with the transfer case 22 and the front axle transmission assembly 3, respectively. Two ends of the rear axle transfer shaft 25 are in transmission connection with the transfer case 22 and the rear axle transmission assembly 4, respectively.

In a specific embodiment, a retractable thruster 26 is mounted inside the vehicle frame 12, and an end of the retractable thruster 26 passes through the streamlined main body 11 and extends outwards. A spray pump transmission shaft 24 is mounted between the transfer case 22 and the retractable thruster 26. The spray pump transmission shaft 24 is configured to supply power when the amphibious vehicle travels on water, and control retraction and power output of the retractable thruster 26 through the vehicle-mounted control system.

The transfer case 22 is an existing structure, and the engine 21 can be connected to the front axle transfer shaft 23, the rear axle transfer shaft 25, and the spray pump transmission shaft 24 through the transfer case 22. When the amphibious vehicle is travelling on the land, the engine 21 can drive the front axle transfer shaft 23 and the rear axle transfer shaft 25 to rotate. When the amphibious vehicle is travelling in water, the engine 21 can drive the spray pump transmission shaft 24 to rotate, which in turn can use the retractable thruster 26 for movement in the water.

In an embodiment, a front axle transmission seat 32 is mounted inside the front axle transmission box 31, and an end of each of the front axle transmission shaft components 33 is connected to the front axle transmission seat 32 through a cardan joint, thereby achieving angular adaptability between each of the front axle transmission shaft components 33 and the front axle transmission seat 32. Another end of each of the front axle transmission shaft components 33 extends outwards and is connected to a front axle steering knuckle 34. A telescopic shaft 36 is disposed in the air spring 35, and a bottom end of the telescopic shaft 36 extends downwards and is rotatably disposed on a top of the front axle steering knuckle 34. Air pressure in air spring 35 of each of the front axle transmission shaft components 33 is configured to be controlled to adaptively adjust the height of front axle.

When the air springs 35 are in operation, the air springs 35 can drive the telescopic shafts 36 to move vertically. When the telescopic shafts 36 move downwards, the air springs 35 can drive the front axle steering knuckles 34 to move downwards. When the front axle steering knuckles 34 move upwards, the air springs 35 can drive the front axle steering knuckles 34 to move upwards. This allows for free height adjustment of the front axle steering knuckles 34.

In a specific embodiment, each of the front axle transmission shaft components 33 includes a first front axle transmission shaft 331, a second front axle transmission shaft 332, and a third front axle transmission shaft 333. The second front axle transmission shaft 332 is connected to the front axle transmission seat 32 through the cardan joint, and an end of the third front axle transmission shaft 333 penetrates through the front axle steering knuckle 34 and is connected to one of the vehicle wheels 13 driven by the wheel hubs 14. The second front axle transmission shaft 332 and the third front axle transmission shaft 333 are in transmission connection with each other through constant velocity joints 334 to ensure a smooth transmission of the front axle transmission shaft component 33 during a steering and a height adjustment process.

The second front axle transmission shaft 332 and the third front axle transmission shaft 333 are in transmission connection with each other through the constant velocity joints 334, so when a height of the third front axle transmission shaft 333 is adjusted, then the second front axle transmission shaft 332 undergoes angular rotation, and the transmission function between the second front axle transmission shaft 332 and the third front axle transmission shaft 333 still can be achieved. The end of the third front axle transmission shaft 333 penetrates through the front axle steering knuckle 34 and is connected to one of the vehicle wheels driven 13 by the wheel hubs 14, which can achieve the transmission function of the front axle transmission assembly 3.

In an embodiment, an end of a front axle upper swing arm 38 and an end of a front axle lower swing arm 39 are rotatably connected to a side wall of the front axle transmission box 31, another end of the front axle upper swing arm 38 is hinged to a bottom end of the telescopic shaft 36, and another end of the front axle lower swing arm 39 is hinged to a bottom end of the front axle steering knuckle 34. A fixed frame 37 is fixedly mounted on a top of the front axle transmission box 31, and a front axle shock absorber 381 with adjustable damping is disposed between an outer side of the fixed frame 37 and the front axle upper swing arm 38. The front axle shock absorber 381 is configured to buffer vibrations of front axle under different road conditions and to adjust a damping value in real-time according to commands of the vehicle-mounted control system.

The front axle upper swing arm 38, the front axle lower swing arm 39, and front axle shock absorber 381 of each of the front axle transmission shaft components can play a role in connecting and buffering the front axle steering knuckle 34 and the front axle transmission box 31 during travelling.

In a specific embodiment, a rear axle transmission seat 42 is mounted inside the rear axle transmission box 41, an end of each of the first rear axle transmission shafts 43 is connected to the rear axle transmission seat 42 through a cardan joint, thereby achieving angular adaptability between each of the first rear axle transmission shafts 43 and the rear axle transmission seat 42. Another end of each of the first rear axle transmission shafts 43 is in transmission connection with an end of a second rear axle transmission shaft 44, another end of the second rear axle transmission shaft 44 is in transmission connection with an end of a third rear axle transmission shaft 45, another end of the third rear axle transmission shaft 45 is connected to one of the vehicle wheels 13 driven by the wheel hubs 14. A rear axle knuckle 46 is movably sleeved on an outer side of the third rear axle transmission shaft 45, a side wall of the worm wheel 47 of each of the electric worm-gear lifting mechanisms and a top end and a bottom end of the rear axle knuckle 46 respectively have a rear axle upper swing arm 461 and a rear axle lower swing arm 462 hinged therebetween, and a rear axle shock absorber 463 with adjustable damping is disposed between the side wall of the worm wheel 47 and an outer side of the rear axle knuckle 46. Each of the electric worm-gear lifting mechanisms in cooperation with a swing arm suspension system are configured to achieve precise adjustment of the height of rear axle and buffering of rear axle.

In an embodiment, the first rear axle transmission shafts 43 and the second rear axle transmission shaft 44 are in transmission connection with each other through a constant velocity joint 334 arranged therebetween, and the second rear axle transmission shaft 44 and the third rear axle transmission shaft 45 are in transmission connection with each other through a constant velocity joint 334 arranged therebetween, thereby ensuring a smooth transmission of the first through third rear axle transmission shafts during a height adjustment process.

In an embodiment, the driving motor 48 is a brushless motor. The vehicle-mounted control system is configured to precisely control a speed and a torque of the brushless motor 48 to drive the worm shaft 49 to rotate and thereby to drive the worm wheel 47 to rotate, achieving a millimeter-level precise adjustment of the height of rear axle, and automatically switch height adjustment strategies based on water and land traveling states to improve passability and adaptability of the amphibious vehicle.

The above illustrates and describes the basic principles, main features, and advantages of the disclosure. Those skilled in the art should understand that the disclosure is not limited by the above embodiments. The above embodiments and the description in the specification only illustrate the principles of the disclosure. Without departing from the spirit and scope of the disclosure, the disclosure may undergo various changes and improvements, all of which fall within the scope of the disclosure. The scope of protection of the disclosure is defined by the appended claims and their equivalents.

What is claimed is:

1. An amphibious vehicle with liftable suspensions, comprising:
a vehicle body (1), a driving assembly (2) mounted inside the vehicle body (1), a front axle transmission assembly (3) mounted inside the vehicle body (1), and a rear axle transmission assembly (4) mounted inside the vehicle body (1);
wherein the front axle transmission assembly (3) and the rear axle transmission assembly (4) are respectively arranged on two ends of the drive assembly (2), and the drive assembly (2) is in transmission connection with the front axle transmission assembly (3) and the rear axle transmission assembly (4);
wherein the front axle transmission assembly (3) comprises:
a front axle transmission box (31), wherein the front axle transmission box (31) is fixedly mounted inside the vehicle body (1), two ends of the front axle transmission box (31) are respectively mounted with front axle transmission shaft components (33), and the front axle transmission shaft components (33) are in transmission connection with the drive assembly (2);
air springs (35), wherein the air springs (35) are disposed above the front axle transmission shaft components (33), respectively, and are configured to adaptively adjust a height of front axle and thereby automatically adjust, through being connected to a vehicle-mounted control system, the height of front axle according to different road conditions;
wherein the rear axle transmission assembly (4) comprises:
a rear axle transmission box (41), wherein the rear axle transmission box (41) is fixedly mounted inside the vehicle body (1), two ends of the rear axle transmission box (41) are mounted with first rear axle transmission shafts (43), and the first rear axle transmission shafts (43) are in transmission connection with the drive assembly (2);
electric worm-gear lifting mechanisms, wherein each of the electric worm-gear lifting mechanisms comprises a worm wheel (47), a worm shaft (49), and a driving motor (48); the worm wheel (47) is rotatably mounted inside the vehicle body (1), and the worm wheel (47) is movably sleeved on an outer side of an end of the first rear axle transmission shaft (43); the worm shaft (49) is meshed with the worm wheel (47), and the driving motor (48) is connected to the worm shaft (49) and configured to drive the worm wheel (47) to rotate to precisely adjust a height of rear axle and thereby automatically adjust, through being connected to the vehicle-mounted control system, the height of rear axle according to water and land traveling states.

2. The amphibious vehicle with liftable suspensions as claimed in claim 1, wherein the vehicle body (1) comprises a streamlined main body (11), a vehicle frame (12), and vehicle wheels (13) driven by wheel hubs (14); the streamlined main body (11) is fixedly sleeved on an outer side of the vehicle frame (12), and the vehicle frame (12) is mounted on outer sides of the drive assembly (2), the front axle transmission assembly (3), and the rear axle transmission assembly (4); the vehicle wheels (13) driven by the wheel hubs (14) are in transmission connection with the front axle transmission shaft components (33) and the first rear axle transmission shafts (43), respectively; the wheel hubs (14) are embedded with driving motors and thereby capable of independently controlling driving torques of the respective vehicle wheels (13) according to driving needs.

3. The amphibious vehicle with liftable suspensions as claimed in claim 2, wherein the driving assembly (2) comprises:
a hybrid power system, wherein the hybrid power system comprises an engine (21), an electric motor, and a transfer case (22); the engine (21) and the electric motor are in transmission connection with the transfer case (22) for flexible power distribution and switching;
a front axle transfer shaft (23), wherein two ends of the front axle transfer shaft (23) are in transmission connection with the transfer case (22) and the front axle transmission assembly (3), respectively;
a rear axle transfer shaft (25), wherein two ends of the rear axle transfer shaft (25) are in transmission connection with the transfer case (22) and the rear axle transmission assembly (4), respectively.

4. The amphibious vehicle with liftable suspensions as claimed in claim 3, wherein a retractable thruster (26) is mounted inside the vehicle frame (12), and an end of the retractable thruster (26) passes through the streamlined main body (11) and extends outwards; a spray pump transmission shaft (24) is mounted between the transfer case (22) and the retractable thruster (26); the spray pump transmission shaft (24) is configured to supply power when the amphibious vehicle travels on water, and control retraction and power output of the retractable thruster (26) through the vehicle-mounted control system.

5. The amphibious vehicle with liftable suspensions as claimed in claim 3, wherein a front axle transmission seat (32) is mounted inside the front axle transmission box (31), and an end of each of the front axle transmission shaft components (33) is connected to the front axle transmission seat (32) through a cardan joint, thereby achieving angular adaptability between each of the front axle transmission shaft components (33) and the front axle transmission seat (32); another end of each of the front axle transmission shaft components (33) extends outwards and is connected to a front axle steering knuckle (34); a telescopic shaft (36) is disposed in the air spring (35), and a bottom end of the telescopic shaft (36) extends downwards and is rotatably disposed on a top of the front axle steering knuckle (34); air pressure in air spring (35) of each of the front axle transmission shaft components (33) is configured to be controlled to adaptively adjust the height of front axle.

6. The amphibious vehicle with liftable suspensions as claimed in claim 5, wherein each of the front axle transmission shaft components (33) comprises a first front axle transmission shaft (331), a second front axle transmission shaft (332), and a third front axle transmission shaft (333); the second front axle transmission shaft (332) is connected to the front axle transmission seat (32) through the cardan joint, and an end of the third front axle transmission shaft (333) penetrates through the front axle steering knuckle (34) and is connected to one of the vehicle wheels (13) driven by the wheel hubs (14); the second front axle transmission shaft (332) and the third front axle transmission shaft (333) are in transmission connection with each other through constant velocity joints (334) to ensure a smooth transmission of the front axle transmission shaft component (33) during a steering and a height adjustment process.

7. The amphibious vehicle with liftable suspensions as claimed in claim 5, wherein an end of a front axle upper swing arm (38) and an end of a front axle lower swing arm (39) are rotatably connected to a side wall of the front axle transmission box (31), another end of the front axle upper swing arm (38) is hinged to a bottom end of the telescopic shaft (36), and another end of the front axle lower swing arm (39) is hinged to a bottom end of the front axle steering knuckle (34); a fixed frame (37) is fixedly mounted on a top of the front axle transmission box (31), and a front axle shock absorber (381) with adjustable damping is disposed between an outer side of the fixed frame (37) and the front axle upper swing arm (38); the front axle shock absorber (381) is configured to buffer vibrations of front axle under different road conditions and to adjust a damping value in real-time according to commands of the vehicle-mounted control system.

8. The amphibious vehicle with liftable suspensions as claimed in claim 2, wherein a rear axle transmission seat (42) is mounted inside the rear axle transmission box (41), an end of each of the first rear axle transmission shafts (43) is connected to the rear axle transmission seat (42) through a cardan joint, thereby achieving angular adaptability between each of the first rear axle transmission shafts (43) and the rear axle transmission seat (42); another end of each of the first rear axle transmission shafts (43) is in transmission connection with an end of a second rear axle transmission shaft (44), another end of the second rear axle transmission shaft (44) is in transmission connection with an end of a third rear axle transmission shaft (45), another end of the third rear axle transmission shaft (45) is connected to one of the vehicle wheels (13) driven by the wheel hubs (14); a rear axle knuckle (46) is movably sleeved on an outer side of the third rear axle transmission shaft (45), a side wall of the worm wheel (47) of each of the electric worm-gear lifting mechanisms and a top end and a bottom end of the rear axle knuckle (46) respectively have a rear axle upper swing arm (461) and a rear axle lower swing arm (462) hinged therebetween, and a rear axle shock absorber (463) with adjustable damping is disposed between the side wall of the worm wheel (47) and an outer side of the rear axle knuckle (46);
each of the electric worm-gear lifting mechanisms in cooperation with a swing arm suspension system are configured to achieve precise adjustment of the height of rear axle and buffering of rear axle.

9. The amphibious vehicle with liftable suspensions as claimed in claim 8, wherein the first rear axle transmission shafts (43) and the second rear axle transmission shaft (44) are in transmission connection with each other through a constant velocity joint (334) arranged therebetween, and the second rear axle transmission shaft (44) and the third rear axle transmission shaft (45) are in transmission connection with each other through a constant velocity joint (334) arranged therebetween, thereby ensuring a smooth transmission of the first through third rear axle transmission shafts during a height adjustment process.

10. The amphibious vehicle with liftable suspensions as claimed in claim 1, wherein the driving motor (48) is a brushless motor; the vehicle-mounted control system is configured to precisely control a speed and a torque of the brushless motor (48) to drive the worm shaft (49) to rotate and thereby to drive the worm wheel (47) to rotate, achieving a millimeter-level precise adjustment of the height of rear axle, and automatically switch height adjustment strategies based on water and land traveling states to improve passability and adaptability of the amphibious vehicle.
